(19) United States
(12) Patent Application Publication
(10) Pub. No.: US 2012/0188284 A1
(43) Pub. Date: Jul. 26, 2012

(54) TOUCH APPARATUS

(75) Inventors: Jar-Ferr YANG, Tainan City (TW); Chi-Chang CHEN, Tainan City (TW); Chun-Yen WU, Hualien County (TW)

(73) Assignee: NATIONAL CHENG KUNG UNIVERSITY, Tainan City (TW)

(21) Appl. No.: 13/355,006

(22) Filed: Jan. 20, 2012

(30) Foreign Application Priority Data
Jan. 21, 2011 (TW) 100102380

(51) Int. Cl. G09G 5/00

(52) U.S. Cl. 345/660

(57) ABSTRACT

A touch apparatus includes a touch panel and a control unit. The touch panel has an input interface, which has a plurality of buttons and a zooming zone. The control unit is electrically connected with the touch panel. When a user touches one of the buttons, the control unit generates a prompt signal corresponding to the button, and a symbol corresponding to the button is magnified and displayed in the zooming zone. When the user then releases the button and doesn't touch the input interface, the symbol or a function corresponding to the button is inputted to the control unit. The touch apparatus has the advantages of assisting visually impaired people to use and simplifying information input.

### CROSS REFERENCE TO RELATED APPLICATIONS

This Non-provisional application claims priority under 35 U.S.C. §119(a) on Patent Application No(s). 100102380 filed in Taiwan, Republic of China on Jan. 21, 2011, the entire contents of which are hereby incorporated by reference.

### BACKGROUND OF THE INVENTION

1. Field of Invention

The present invention relates to an electronic apparatus and, in particular, to a touch-control electronic apparatus.

2. Related Art

In the recent years, many touch-control electronic products, such as tablet computers, cell phones, or GPS, have been manufactured and sold. These products have the touch control function, so that the user can directly touch or press the text, function or picture on the touch panel so as to operate the touch apparatus.

For a conventional touch apparatus, the user usually clicks or double-clicks the virtual button on the touch panel so as to select the corresponding symbol, text, function or picture. In this input operation, it is usually to see the displayed symbols, texts, functions or pictures, and then to click the desired one by finger or stylus. When the finger or stylus touch the button on the touch panel displayed with the desired symbol, text, function or picture, the select and input operations are finished.

However, the click input operation for the conventional touch apparatus must catch the displayed virtual buttons and search the desired ones. Although this operation is familiar to the normal users, it may cause the operation problem to the visually impaired people. In other words, regarding to the visually impaired people, it is difficult or impossible to operate the conventional touch apparatus.

Therefore, it is an important subject of the present invention to provide a touch apparatus that can assist visually impaired people to use and simplify information input.

### SUMMARY OF THE INVENTION

In view of the foregoing subject, an objective of the present invention is to provide a touch apparatus that can assist visually impaired people to use and simplify information input.

To achieve the above, the present invention discloses a touch apparatus including a touch panel and a control unit. The touch panel has an input interface, which has a plurality of buttons and a zooming zone. The control unit is electrically connected with the touch panel. When a user touches one of the buttons, the control unit generates a prompt signal corresponding to the button, and a symbol corresponding to the button is magnified and displayed in the zooming zone. When the user then releases the button and doesn't touch the input interface, the symbol or a function corresponding to the button is inputted to the control unit.

In one embodiment of the present invention, the prompt signal is a sound signal.

In one embodiment of the present invention, after the symbol corresponding to the button is inputted to the control unit, the control unit controls the input interface to display only buttons and their corresponding symbols relating to the button.

In one embodiment of the present invention, when the left side of another button relating to the button displayed on the input interface has a blank area, and the user touches the another button or the blank area, the control unit generates another prompt signal corresponding to the another button, and a symbol corresponding to the another button is magnified and displayed in the zooming zone.

In one embodiment of the present invention, when the left side of another button relating to the button displayed on the input interface has a displayed button and a corresponding symbol while the right side of the another button has a blank area, and the user touches the another button or the blank area, the control unit generates another prompt signal corresponding to the another button, and a symbol corresponding to the another button is magnified and displayed in the zooming zone.

In one embodiment of the present invention, when the user releases the another button or the blank area and doesn't touch the input interface, the symbol corresponding to the another button is inputted to the control unit.

In one embodiment of the present invention, after the symbol corresponding to the button is inputted to the control unit, the control unit controls the input interface to normally display the buttons and the corresponding symbols relating to the button, and fades away symbols corresponding to buttons that are not relating to the button.

In one embodiment of the present invention, when the user touches a symbol corresponding to another button that is normally displayed or faded away, the control unit generates another prompt signal corresponding to the another button, and a symbol corresponding to the another button is magnified and displayed in the zooming zone.

In one embodiment of the present invention, when the user release the another button and doesn't touch the input interface, the symbol corresponding to the another button is inputted to the control unit.

In one embodiment of the present invention, when the user touches the symbol corresponding to the another button that is normally displayed or faded away, the control unit generates different prompt signal.

In one embodiment of the present invention, the input interface further has a text zone, and when the user touches the text zone, the control unit generates another prompt signal corresponding to the text zone.

As mentioned above, in the touch apparatus of the present invention, when a user touches one of the buttons, the control unit generates a prompt signal corresponding to the button, and a symbol corresponding to the button is magnified and displayed in the zooming zone. According to this feature, the touch apparatus of the present invention can help visually impaired people to realize the symbol or function corresponding to the selected button by the prompt signal and the magnifying display function. Then, when the user releases the button and doesn't touch the input interface, the symbol or function corresponding to the button is inputted to the control unit. Accordingly, after the button of the touch apparatus is touched and released, the selected symbol can be successfully inputted. The touch apparatus of the present invention has the advantage of simplifying the text input. Besides, due to the assistance of the present invention, the visually impaired people can easily learn how to use the touch apparatus and to input texts, so that the touch apparatus of the present invention can also assist visually impaired people to use.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a block diagram of a touch apparatus according to a preferred embodiment of the present invention;

FIG. 1B is a schematic diagram showing the touch apparatus;

FIGS. 2A to 2E are schematic diagrams showing the procedure for using the touch apparatus to input Chinese words;

FIGS. 3A to 4C are schematic diagrams showing the procedure for using the touch apparatus to revise an article;

FIGS. 5A to 5C are schematic diagrams showing the procedure for using the touch apparatus to input English words; and

FIG. 6 is a flow chart of an information input method according to the present invention.

### DETAILED DESCRIPTION OF THE INVENTION

The present invention will be apparent from the following detailed description, which proceeds with reference to the accompanying drawings, wherein the same references relate to the same elements.

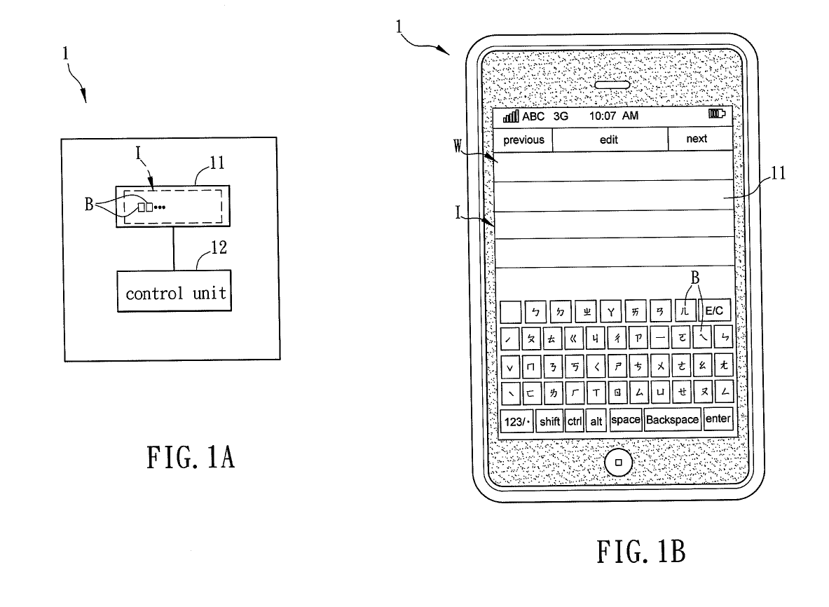

FIG. 1A is a block diagram of a touch apparatus 1 according to a preferred embodiment of the present invention, and FIG. 1B is a schematic diagram showing the touch apparatus 1.

Referring to FIGS. 1A and 1B, the touch apparatus 1 includes a touch panel 11 and a control unit 12. The touch apparatus 1 can be a computer, a cell phone, a stereo set, an electronic machine, an ATM, or a GPS. The computer can be a tablet computer, a desktop computer, or a laptop computer. To be noted, the touch apparatus 1 is not limited to be offered for visually impaired people to use, and of course, it can be offered for normal people to use. In this embodiment, the touch apparatus 1 is a cell phone for example.

The touch panel 11 has an input interface I, which has a plurality of buttons B and a zooming zone. In this case, the buttons B are virtual buttons, and the buttons B may include symbol buttons and functional buttons. In this embodiment, the input interface I is a text input interface such as a phonetic (Zhuyin) input interface (using phonetic (Zhuyin) input method). Of course, the input interface I can use other input methods such as a Cangjie input interface (input method), Boshiamy input interface (input method), or English input interface. Besides, the input interface I can be, for example but not limited to, a text input interface for any edit software, or an input interface for inputting text or function in other software or website.

The control unit 12 is electrically connected with the touch panel 11. In this case, the touch panel 11 and the control unit 12 are integrated as a touch apparatus 1. In other embodiments, the control unit 12 and the touch panel 11 may be dependently configured. Moreover, the input interface I further includes a text zone W such as a text input area or other area for article editing.

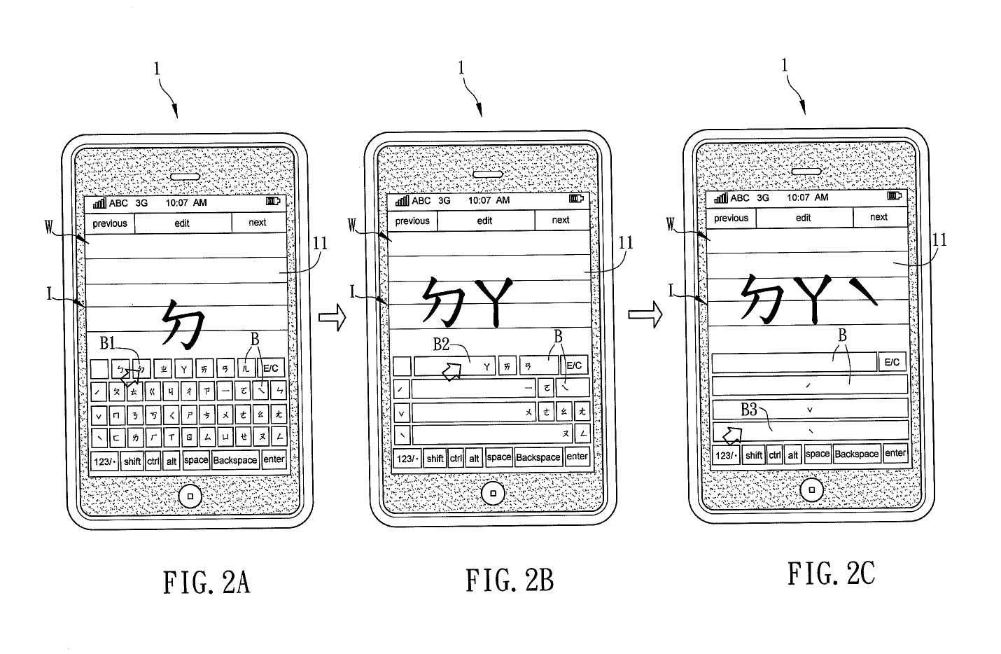

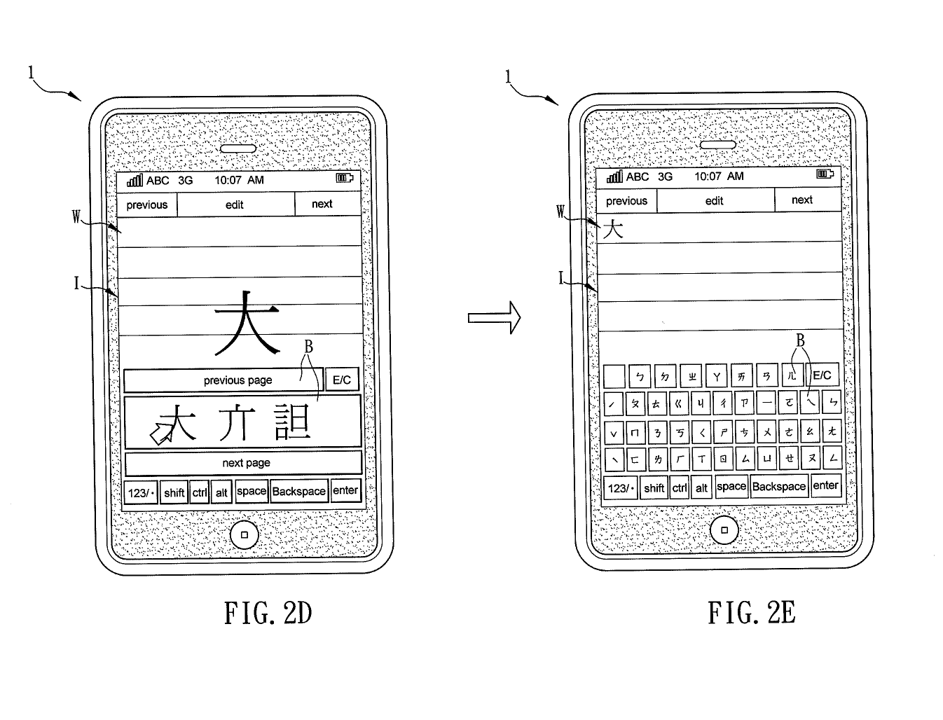

The operation method of the touch apparatus 1 and text input procedures thereof will be described hereinafter with reference to FIGS. 1A and 2A. The following example is to input a Chinese word “ [symbol] ”, and the arrow shown in the figures indicates the finger of the user.

When the user uses his finger to touch a button B1, which is one of the buttons B of the input interface I, the control unit 12 (not shown in FIG. 2A) can control to magnify and display the symbol corresponding to the button B1 on the zooming zone. Besides, the control unit 12 also generates a prompt signal corresponding to the button B1. In this case, the zooming zone can be an individual area or integrated with other areas. In this embodiment, the zooming zone is located within the text zone W of the input interface I. In other embodiments, the zooming zone can be located in another position in the input interface I other than in the text zone W.

In this embodiment, the first input button B1 corresponds to a symbol “ [symbol] ”, and the control unit 12 controls to magnify and display the symbol “ [symbol] ” on the zooming zone. Herein, the arrow over the symbol “ [symbol] ” represents the finger of the user. The function of magnifying and displaying symbol “ [symbol] ” corresponding to the button B1 is to allow the low-vision people to realize which button is touched to view the magnified symbol.

In addition, the prompt signal is a sound signal. The sound signal can be a pronunciation of the symbol or a name of a function corresponding to the button B1. In other words, the button B1 of this embodiment is a phonetic symbol “ [symbol] ”, so the control unit 12 controls a prompt unit (not shown), such as a speaker, to output a sound like “d”. If the button B1 touched by the user is a functional button (e.g. the delete key, space key, backspace key, enter key, ctrl key, or the likes), the control unit 12 controls the prompt unit to output the name of the functional button. Accordingly, the control unit 12 can control the prompt unit to output the recognizable prompt signal, which allows the visually impaired people to know which button is touched, so that the visually impaired people can easily perform the desired select and input operation.

Referring to FIGS. 2A and 2B, after the user releases the button B1 and doesn't touch the input interface, the symbol “ [symbol] ” corresponding to the button B1 is inputted to the control unit 12. Otherwise, if the touched button is a functional key, the function corresponding to the button is inputted to the control unit 12. In other words, when searching the desired button on the touch panel 11, a visually impaired user must put his finger (or a stylus) on the input interface I of the touch panel 11 and then move it. This operation is similar to the vision searching of normal user. When the finger touches a selectable button, the touch apparatus 1 outputs a prompt signal (e.g. voice) to acknowledge the user about the symbol or the name of the function corresponding to the button. If the current touched button B1 is the desired selection, the user can simply rise his finger to release the button and doesn't touch any area of the input interface I, thereby finishing the operation of selecting and inputting the button B1. Since the symbol corresponding to the desired button is inputted as the finger (or stylus) leaves the button, this technique is called “release input”. Accordingly, the visually impaired user can perform input operation with the touch apparatus 1 by relying on the sense of touch and hearing.

To be noted, the symbol corresponding to the button B can be any of the phonetic symbols such as “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “T”, “ [symbol] ”, “ [symbol] ”, “ [symbol] ”, “ [symbol] ”, “ [symbol] ”, “ [symbol] ”, “ [symbol] ”, “-”, “ [symbol] ”, “ [symbol] ”, “Y”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “^{.}”, or other functional texts. In addition, when the user inputs the function corresponding the functional key to the control unit 12 by the release input technique, the control unit 12 can then execute this function.

After inputting the symbol “ [symbol] ” corresponding to the button B1 to the control unit 12, the control unit 12 controls the input interface I to display only the buttons related to the button B1 and their corresponding symbols. The buttons related to the button B1 include all possible buttons following the button B1. In other words, after the user inputs the symbol B1, many symbols may not follow the symbol B1.

For example, when the symbol corresponding to the button B1 is “ [symbol] ”, the following symbol can not be any of “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “T”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, and “ [symbol] ”. Thus, the symbols “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “T”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, and “ [symbol] ” are not related to the symbol “ [symbol] ” corresponding to the button B1, while the rest symbols are related to the symbol “ [symbol] ” corresponding to the button B1. Consequently, the control unit 12 controls the input interface I to display only the buttons related to the button B1 and their corresponding symbols. In this case, the input interface I only displays the symbols “⁻”, “ [symbol] ”, “Y”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, and “^{.}” as well as their corresponding buttons. Referring to FIG. 2B, since the symbols that are not related to the symbol “ [symbol] ” are disappeared, the control unit 12 can control the input interface I to magnify and display the buttons corresponding to the displayed symbols.

As mentioned above, after inputting a symbol, the control unit 12 of the touch apparatus 1 can control to erase the unnecessary buttons and their corresponding symbols. This feature can reduce the possible selecting number of symbols, thereby decreasing the time for selecting the next button and inputting.

In addition, the touch apparatus 1 may preset the correlations of every symbol followed by another symbol in different input methods. Accordingly, after the symbol is inputted to the control unit 12, the input interface I is controlled to display only the buttons related to the symbol and their corresponding symbols. This can reduce the possible selections of inputting and thus make the input speed of the user faster. Besides, the control unit 12 can merge the spaces occupied by the disappeared symbols to the existing symbols on the input interface I, so that the areas of the buttons corresponding to the existing symbols can be enlarged. For examples, as shown in FIG. 2B, the areas of the symbols “Y”, “^{-”, “} [symbol] ^{”, “} [symbol] ^{”, “} [symbol] ^{”, and “} [symbol] ^{”, are enlarged, so that the user can easily select the next button and the corresponding symbol. In addition, the positions of the possible following symbols does not change in spite of the occupied areas are enlarged. This feature allows the user learning about this new input method to quickly remember the button positions of all symbols, thereby making the input speed faster.}

If the left side of the displayed buttons has a blank area, which refers to the non-displayed symbols, the button corresponding to the displayed symbol is extended towards the left side. For example, the buttons corresponding to the symbols “Y”, “^{-”, “} [symbol] ^{”, and “} [symbol] ^{” are extended towards their left sides to occupy the left-side areas referring to the non-displayed symbols. Otherwise, if the left side of the displayed buttons does not have a blank area, which refers to the non-displayed symbols, but the right side thereof does, the button corresponding to the displayed symbol is extended towards the right side. For example, the buttons corresponding to the symbols “} [symbol] ^{”, and “} [symbol] ^{” are extended towards their right sides to occupy the right-side areas referring to the non-displayed symbols.}

When the left side of another button B2 relating to the button B1 displayed on the input interface I has a blank area, and the user touches the button B2 or the blank area, the control unit 12 generates another prompt signal corresponding to the button B2, and a symbol corresponding to the button B2 is magnified and displayed in the zooming zone. Otherwise, when the left side of another button B2 relating to the button B1 displayed on the input interface I has a displayed button and a corresponding symbol while the right side of the button B2 has a blank area, and the user touches the button B2 or the blank area, the control unit 12 generates another prompt signal corresponding to the button B2, and a symbol corresponding to the button B2 is magnified and displayed in the zooming zone.

In this embodiment, the next inputted symbol is “Y”, so that when the user touches the button B2 or the left-side blank area (this case shows that the user touches the left-side blank area), the control unit 12 generates another prompt signal (e.g. the pronunciation of “Y”) corresponding to the button B2. As shown in FIG. 2B, the symbols “ [symbol] ” and “Y” corresponding to the buttons B1 and B2 are magnified and displayed in the zooming zone.

Moreover, when the user releases the button B2 or the blank area and doesn't touch the input interface I, the symbol “Y” corresponding to the button B2 is inputted to the control unit 12. In this case, the symbol “Y” corresponding to the button B2 is the exactly desired symbol, so the user rises his finger to release the button B2, thereby inputting the symbol “Y” to the control unit 12.

To be noted, if an incorrect symbol is unintentionally inputted, the user can select the functional key “edit” of the input interface I to delete the inputted incorrect symbol and input the correct one again. In this case, the user can move his finger on the position of the functional key “edit” of the input interface I, and then the control unit 12 controls the prompt unit to output a voice of “edit”. After the user releases his finger from the input interface I, the edit function is inputted to the control unit 12, thereby erasing the previously inputted symbol. Then, the user can input a new and correct symbol again.

Referring to FIGS. 2B and 2C, after the symbol “Y” is inputted, the related buttons only include the tone buttons as well as the always displayed functional buttons, so the spaces of the tone buttons are enlarged. When the user touches the tone button B3 corresponding to the symbol “ [symbol] ”, the control unit 12 controls the prompt unit to output a corresponding prompt signal, and to magnify and display the symbol “ [symbol] ” following the symbol “Y” on the zooming zone. When the user rises his finger to release the button B3 and does not touch the input interface I, the symbol “ [symbol] ” is successfully inputted to the control unit 12.

When the symbols “ [symbol] ”, “Y” and “ [symbol] ” are inputted to the control unit 12, the Chinese words indicating by these set of symbols are all displayed as shown in FIG. 2D. According to the above-mentioned operations of selecting buttons and symbols, when the user touches the button with the displayed word on the touch panel 11, the control unit 12 can generate a prompt signal corresponding to this word. For example, the control unit 12 can control the prompt unit to pronounce “da” to indicate the Chinese word “ [symbol] ”. Accordingly, the visually impaired user can release whether the touched button is the desired one. After the user release the button, the Chinese word “ [symbol] ” is inputted to the control unit 12, and then the text zone W of the input interface I displays the Chinese word “ [symbol] ”. After the Chinese word “ [symbol] ” is displayed on the text zone W, all buttons B including to symbol buttons and functional buttons are displayed as the initial status.

According to the above-mentioned operations, the user can use the touch apparatus 1 of the present invention to input words, which are displayed on the text zone W one by one. In addition, when the user touches the text zone W, the control unit 12 can also generate a prompt voice corresponding to the text zone W. For example, as shown in FIG. 2E, when the user moves his finger on the text zone W, the control unit 12 controls the prompt unit to pronounce a prompt voice of “da”.

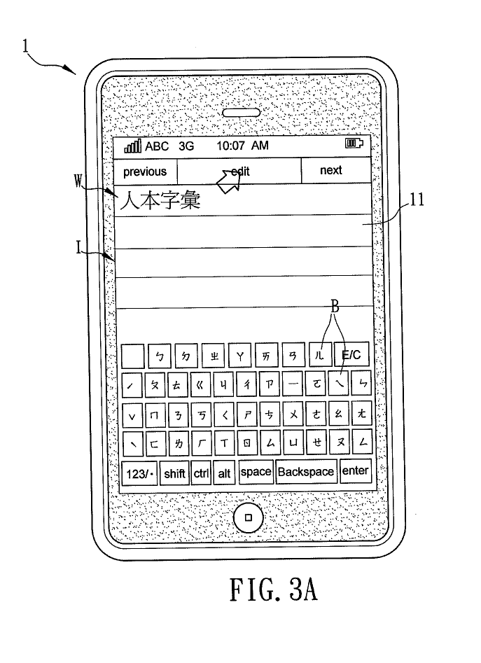

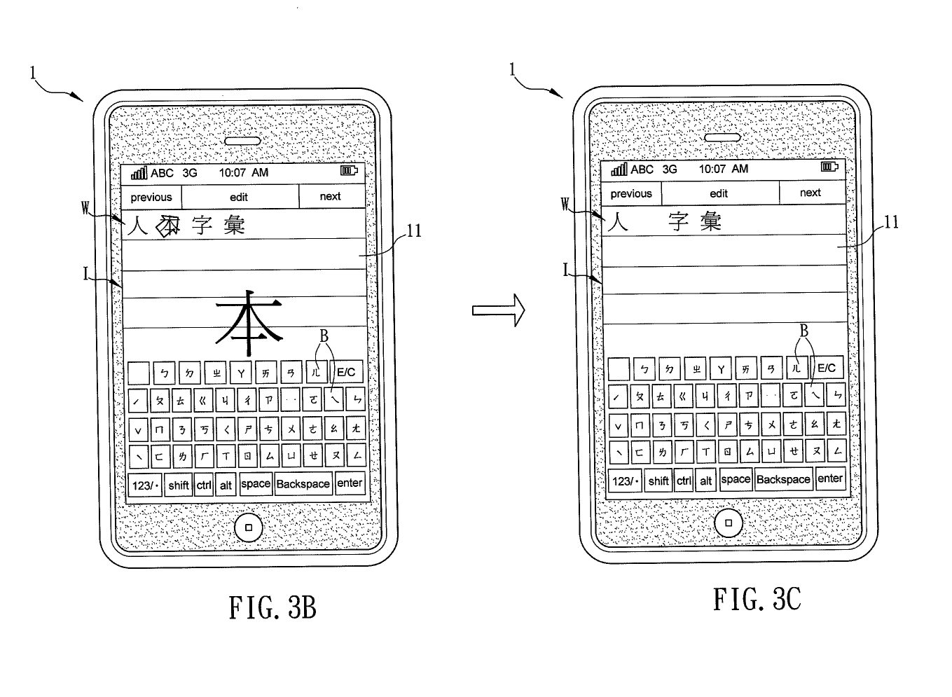

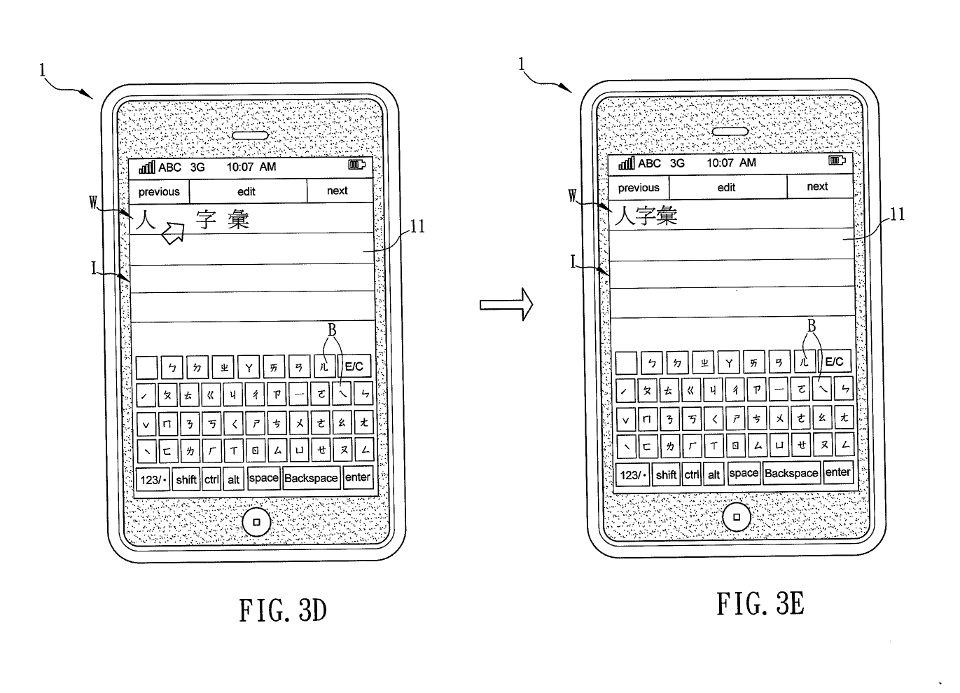

With reference to FIG. 3A, if the user wants to edit the inputted words in the text zone W while no other phonetic symbol is currently inputted, the user can directly select the functional key “edit” on the top of the screen (the prompt voice of this functional key is also generated as the user's finger is moved on the functional button). Referring to FIGS. 3B and 3C, the word to be edited is selected by moving the finger thereon (the prompt voice of this word is also generated as the user's finger is moved thereon, and the selected word is magnified and displayed on the zooming zone). For example, if the user touches the word “ [symbol] ” and then releases it, the word “ [symbol] ” is disappeared and replaced by a blank space. Then, the user can input a new word into this blank space by the above-mentioned operation.

Referring to FIGS. 3D and 3E, if the user decides to not input a new word to the blank space, the user can move his finger behind the blank space and then rise the finger. After that, the rest words at the right side are all moved leftwards for one word space.

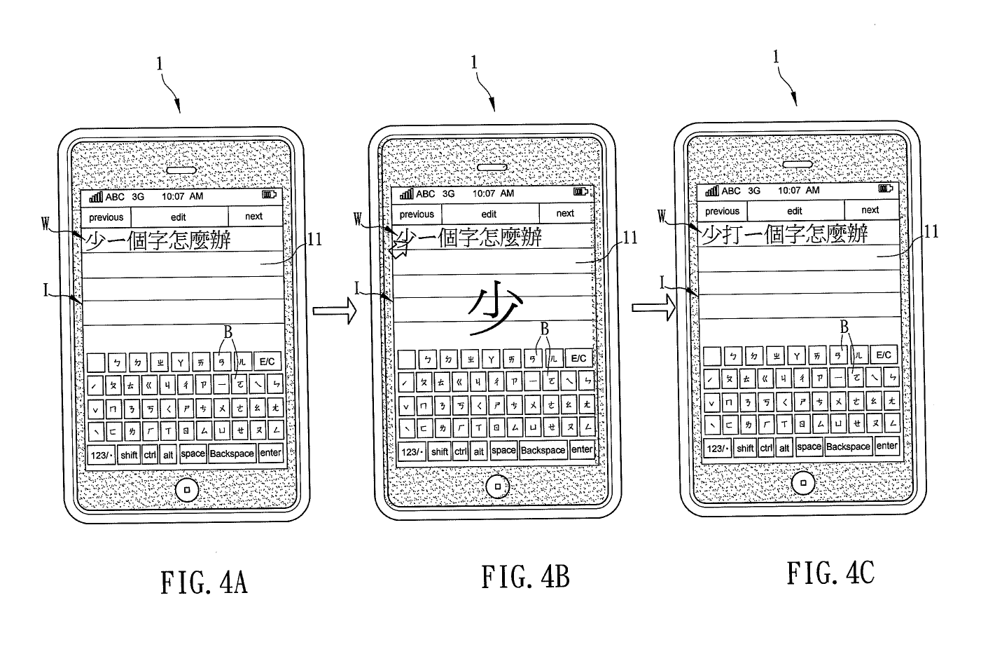

With reference to FIGS. 4A to 4C, if the user finds that a word is missing in an article and would like to insert a new word, the user can move his finger on one of the displayed words and then rise the finger, thereby moving the text cursor to the right side of the selected word. After that, the user can follow the above-mentioned operation to input a new word behind the selected word.

For example, as shown in FIG. 4A, if a new word “ [symbol] ” is to be inserted behind the existing word “ [symbol] ”, the user moves his finger on the word “ [symbol] ” and then rise the finger, thereby moving the text cursor to the right side of the selected word “ [symbol] ”. Then, the user can follow the above-mentioned operation to input a new word “ [symbol] ” behind the selected word “ [symbol] ”. Of course, after moving the text cursor to the right side of the selected word, it is also possible to delete the selected word by pressing the function button “backspace”.

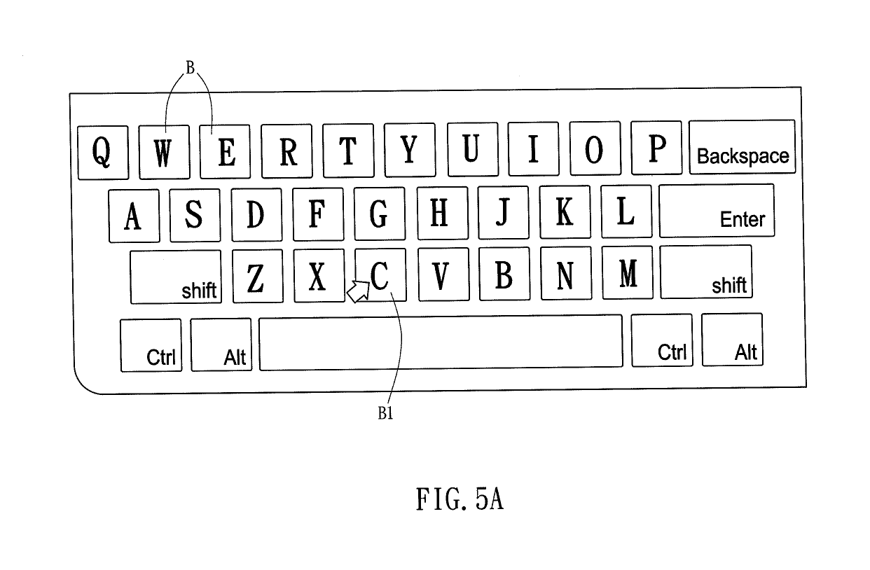

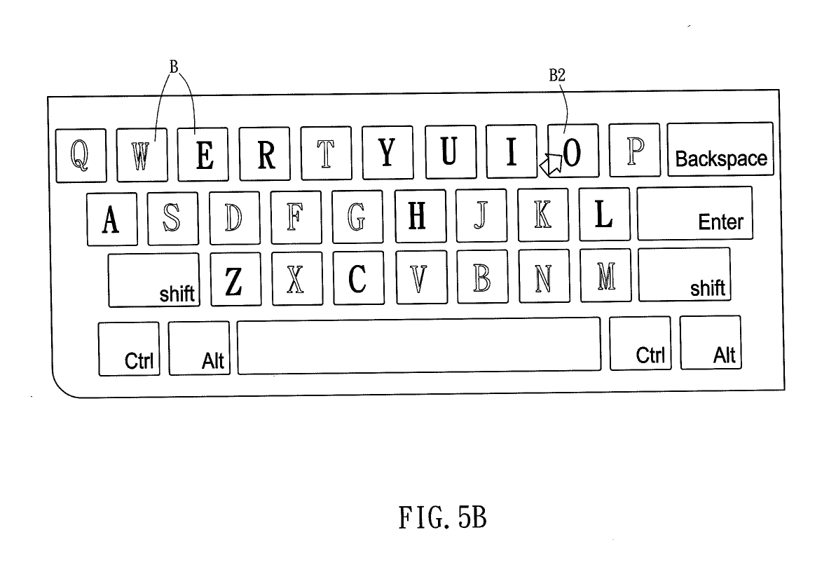

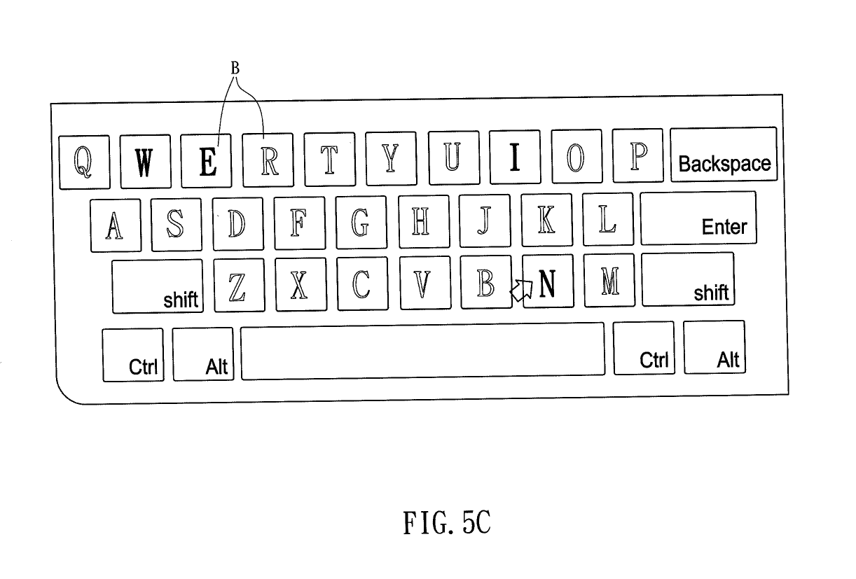

Referring to FIG. 1B again, the buttons B includes a functional button “E/C”. If the function of the function button “E/C” is inputted to the control unit 12, the touch apparatus 1 is switched to the English input mode. The example of using the touch apparatus 1 to input English words will be described hereinafter with reference to FIGS. 5A to 5C. To be noted, FIGS. 5A to 5C only show the bottom half including the input buttons B as shown in FIG. 1B, and the top half including the text zone W and other portions is not shown.

After pressing the functional button “E/C” as shown in FIG. 1B, the buttons B of the input interface I are changed and show English letters as shown in FIGS. 5A to 5C. If the user wants to input a word “COGNITION”, he can follow the above-mentioned operation to input the desired word. For example, the user moves his finger to the button B1 corresponding to the symbol “C”. In this case, the prompt voice of the symbol “C” is generated, and the symbol “C” is magnified and displayed on the zooming zone. After the user releases the button B1 and does not touch the input interface I, the symbol “C” is successfully inputted to the control unit 12, and the symbol “C” is displayed on the text zone W (not shown in FIG. 5A).

Referring to FIG. 5B, after the symbol “C” is inputted, the control unit 12 controls the input interface I to normally display the buttons B relating to the button B1 and the corresponding symbols, and fades away symbols corresponding to other buttons B that are not relating to the button B1. In other words, as shown in FIG. 5B, some buttons B relating to the button B1 and the corresponding symbols are normally displayed, while the symbols corresponding to other buttons that are not relating to the symbol “C” are faded away. In some cases, the next symbol to be inputted may be not relating the previously inputted symbol such as for proper nouns or abbreviations. Accordingly, some letters that are not relating to the symbol “C” are faded away. Since these symbols are faded away instead of being disappeared, the user can still select these faded symbols if desired.

As shown in FIG. 5B, after inputting the symbol “C”, the user touches a normally displayed button B2 corresponding to the symbol “O”. Then, the user releases the button B2 and does not touch the input interface I, so that the symbol “O” corresponding to the button B2 is successfully inputted to the control unit 12. Of course, as the above-mentioned operation for inputting phonetic symbols, when the user touches a normally displayed or faded button B2, the control unit 12 can also generate another prompt signal corresponding to the button B2, and the symbol corresponding to the selected button B2 is magnified and displayed on the zooming zone.

Further to input another symbol “G” following the above operation, as shown in FIG. 5C, only four symbols, including symbols “W”, “E”, “I”, and “N”, as well as the corresponding buttons B are still normally displayed (the other letters are faded away). Accordingly, the speed for inputting English words can be increased.

To be noted, when the user another normally displayed or faded button, the control unit 12 can generate different prompt signals, so that the visually impaired user can easily recognize what button is touched. For example, when the user touches another normally displayed or faded button, the prompt unit can generate prompt voices with different tones. Otherwise, the normally displayed button corresponds to a prompt voice as the faded button corresponds to a vibration, so that the user can easily distinguish them.

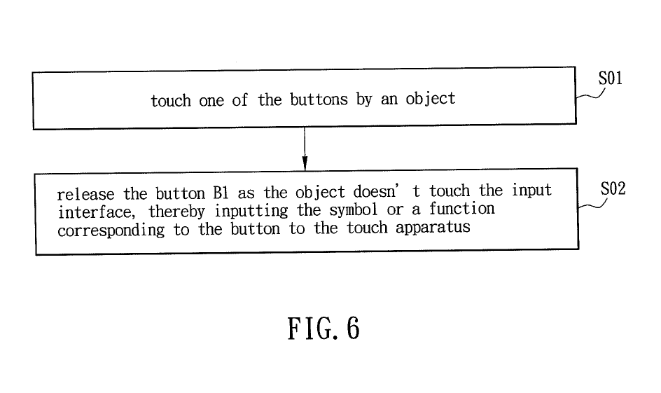

An information input method applied to the touch apparatus 1 of the present invention will described hereinafter with reference to FIGS. 1A and 6. Herein, the touch apparatus 1 includes a touch panel 11, which has an input interface I with a plurality of buttons B. The information input method includes the following steps S01 and S02.

The step S01 is to touch a button B1, which is one of the buttons B, by an object. In this case, when the object touches the button B1, the touch apparatus 1 generates a prompt signal, and the symbol corresponding to the button B1 is magnified and displayed on the zooming zone. The object can be a finger of the user, a stylus, or other object.

The step S02 is to release the button B1 as the object doesn't touch the input interface I, thereby inputting the symbol or a function corresponding to the button B1 to the touch apparatus 1. In this case, the object is risen to release the button B1 and the user does not touch any place of the input interface I, so that the symbol or function of the button B1 is successfully inputted to the touch apparatus 1.

Since the other technical features of the touch apparatus 1 have been discussed in the above embodiment, the detailed description thereof will be omitted.

In summary, when a user touches one of the buttons, the control unit generates a prompt signal corresponding to the button, and a symbol corresponding to the button is magnified and displayed in the zooming zone. According to this feature, the touch apparatus of the present invention can help visually impaired people to realize the symbol or function corresponding to the selected button by the prompt signal and the magnifying display function. Then, when the user releases the button and doesn't touch the input interface, the symbol or function corresponding to the button is inputted to the control unit. Accordingly, after the button of the touch apparatus is touched and released, the selected symbol can be successfully inputted. The touch apparatus of the present invention has the advantage of simplifying the text input. Besides, due to the assistance of the present invention, the visually impaired people can easily learn how to use the touch apparatus and to input texts, so that the touch apparatus of the present invention can also assist visually impaired people to use.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch apparatus, comprising:
a touch panel having an input interface, wherein the input interface has a plurality of buttons and a zooming zone; and
a control unit electrically connected with the touch panel, wherein when a user touches one of the buttons, the control unit generates a prompt signal corresponding to the button, and a symbol corresponding to the button is magnified and displayed in the zooming zone, and then when the user releases the button and doesn't touch the input interface, the symbol or a function corresponding to the button is inputted to the control unit.

2. The touch apparatus of claim 1, wherein the prompt signal is a sound signal.

3. The touch apparatus of claim 1, wherein after the symbol corresponding to the button is inputted to the control unit, the control unit controls the input interface to display only buttons and their corresponding symbols relating to the button.

4. The touch apparatus of claim 3, wherein when the left side of another button relating to the button displayed on the input interface has a blank area, and the user touches the another button or the blank area, the control unit generates another prompt signal corresponding to the another button, and a symbol corresponding to the another button is magnified and displayed in the zooming zone.

5. The touch apparatus of claim 3, wherein when the left side of another button relating to the button displayed on the input interface has a displayed button and a corresponding symbol while the right side of the another button has a blank area, and the user touches the another button or the blank area, the control unit generates another prompt signal corresponding to the another button, and a symbol corresponding to the another button is magnified and displayed in the zooming zone.

6. The touch apparatus of claim 4, wherein when the user releases the another button or the blank area and doesn't touch the input interface, the symbol corresponding to the another button is inputted to the control unit.

7. The touch apparatus of claim 5, wherein when the user releases the another button or the blank area and doesn't touch the input interface, the symbol corresponding to the another button is inputted to the control unit.

8. The touch apparatus of claim 1, wherein after the symbol corresponding to the button is inputted to the control unit, the control unit controls the input interface to normally display the buttons and the corresponding symbols relating to the button, and fades away symbols corresponding to buttons that are not relating to the button.

9. The touch apparatus of claim 8, wherein when the user touches a symbol corresponding to another button that is normally displayed or faded away, the control unit generates another prompt signal corresponding to the another button, and a symbol corresponding to the another button is magnified and displayed in the zooming zone.

10. The touch apparatus of claim 9, wherein when the user release the another button and doesn't touch the input interface, the symbol corresponding to the another button is inputted to the control unit.

11. The touch apparatus of claim 8, wherein when the user touches the symbol corresponding to the another button that is normally displayed or faded away, the control unit generates different prompt signal.

12. The touch apparatus of claim 1, wherein the input interface further has a text zone, and when the user touches the text zone, the control unit generates another prompt signal corresponding to the text zone.
